(19) United States
(12) Patent Application Publication
(10) Pub. No.: US 2010/0266850 A1
(43) Pub. Date: Oct. 21, 2010

(54) LAMINATE, METHOD FOR PRODUCING LAMINATE, FLEXIBLE PRINTED CIRCUIT BOARD, AND METHOD FOR MANUFACTURING FLEXIBLE PRINTED CIRCUIT BOARD

(76) Inventors: Kanji Shimoohsako, Kyoto (JP); Takashi Kikuchi, Shiga (JP); Takashi Ito, Shiga (JP); Shigeru Tanaka, Shiga (JP)

Correspondence Address: BIRCH STEWART KOLASCH & BIRCH, PO BOX 747, FALLS CHURCH, VA, 22040-0747, US

(21) Appl. No.: 12/746,959

(22) PCT Filed: Dec. 3, 2008
(86) PCT No.: PCT/JP2008/071972

§ 371 Date: Jun. 9, 2010

(30) Foreign Application Priority Data
Dec. 11, 2007 (JP) 2007-319307
Dec. 11, 2007 (JP) 2007-319310

(51) Int. Cl. B32B 27/34; B32B 9/04; B05D 3/02; B05D 3/12

(52) U.S. Cl. 428/411.1; 427/372.2; 427/289; 427/385.5

(57) ABSTRACT

An object of the present invention is to improve, in a laminate and a flexible printed circuit board obtained using the laminate, (i) adhesiveness between a resin material and a plating layer and (ii) soldering heat resistance after moisture absorption. This object is attained by a method for producing a laminate including at least a polymer film, a to-be-plated layer containing at least a crystalline thermoplastic resin, and a plating layer, said method including the steps of: A) applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer: and B) heating the laminate.

### TECHNICAL FIELD

The present invention relates to a laminate, a method for producing a laminate, a flexible printed circuit board, and a method for manufacturing a flexible printed circuit board.

### BACKGROUND ART

In recent years, electronic devices have higher performance, more sophisticated functions, and lighter weight. This has increased the demand for smaller and lighter electronic components for use in the electronic devices. Along with this demand, a method for packaging a semiconductor element and a printed circuit board having a packaged semiconductor element mounted thereon are requested to provide a higher density, more sophisticated functions, and higher performance.

Typically, a flexible printed circuit board (hereinafter, also referred to as “FPC”) has a configuration obtained in the following manner: A metal-clad laminate is produced by bonding a metal foil onto a surface of a substrate (base film) with an adhesive material under heating and pressure, the substrate being made of a flexible, thin insulating film; then, a circuit pattern is formed on the metal-clad laminate, and a cover layer is applied on a surface thereof. Such a flexible printed circuit board (three layer FPC) made of an insulating film, an adhesive layer, and a metal foil generally uses a polyimide film or the like as the insulating film. This is because that the polyimide has excellent heat resistance, electric properties, etc. Typically used as the adhesive layer is a thermosetting adhesive agent such as an epoxy resin adhesive agent, an acrylic resin adhesive agent, or the like.

However, in order to obtain an FPC having a higher density, more sophisticated functions, and higher performance as described above, it is necessary to impart higher performance to the insulating adhesive agent and the insulating film, each used as materials of the FPC, and to use them. Specifically, the adhesive layer and the like are requested to have higher heat resistance and mechanical strength, and further to be excellent in processibility, adhesiveness, low moisture absorption properties, electric properties, and dimensional stability.

Meanwhile, a thermosetting resin such as an epoxy resin or an acrylic resin, which is generally used as the adhesive layer, allows adhesion at relatively low temperatures. Thus, the thermosetting resin is excellent in processibility at low temperatures, and, furthermore, is cost effective. However, other properties, e.g., soldering heat resistance, of the thermosetting resin are not adequate.

In order to solve this problem, there has been proposed a two layer FPC in which a polyimide material is used also in an adhesive layer (for example, see Patent Literature 1). To be exact, this type of FPC, obtained by the method that uses the polyimide material in the adhesive layer, may be regarded as a three layer FPC; however, considering the two polyimide layers as an integrated one, this is called “two layer FPC”. This two layer FPC is superior in heat resistance, electric properties, and dimensional stability to a three layer FPC that includes an adhesive layer made of an epoxy resin or an acrylic resin, and therefore attracts attention as a material that can respond to properties that will be demanded in the future.

However, the use of the polyimide material involves a disadvantage of a high water absorption rate caused by the properties of polyimide. This problem applies to the two layer FPC, too. If an FPC has a high water absorption rate, this may cause adverse effects in mounting of a component by means of soldering. Specifically, heating during the mounting of the component causes moisture which has been taken in the material from the atmosphere to be rapidly released to the outside of the system. This may result in blistering and/or whitening in the FPC, thereby causing a problem in (i) adhesiveness between materials used in the FPC and/or in (ii) the electric properties of the FPC.

Further, there also is a problem in forming fine wires, which are demanded recently. In order to obtain fine wires, the wires should be formed to have a reduced thickness. However, the use of a thin metal foil may involve the disadvantage(s) that: it is trouble some to handle the metal foil; properties such as adhesiveness, soldering heat resistance, etc. are not attained; and/or the like.

Here, consider a case where a double-sided FPC is manufactured. After a through-hole is formed, the through-hole is subjected to electroless plating and further to electroplating. Consequently, the through-hole obtains conductivity. However, since the plating layer is formed also on the metal foil, a thickness of the metal layer is increased. This increases a wire height to wire width ratio, thereby making it difficult to form fine wires.

One way to solve this problem is a method for directly forming electroless plating on a heat-resistant resin material such as polyimide. Consider a case where a double-sided FPC is manufactured by this method. In such a case, a through-hole is formed, and the through-hole is directly subjected to electroless plating and further to electroplating. Consequently, the through-hole obtains conductivity, and, at the same time, the metal layer obtains a desired thickness. Thus, this method can control a wire height to wire width ratio, and therefore is suitable to form fine wires. Further, this method does not need (i) a step for deposition of a metal foil or (ii) a metal foil itself. Thus, this method is also cost effective.

However, if the above method is applied to a heat-resistant resin material such as polyimide, problems of (i) low adhesiveness between an electroless plating film and an insulating material and (ii) failure to achieve sufficient soldering heat resistance after moisture absorption occur, since the electroless plating film is formed so as to be deposited on the resin.

In order to solve these problems, such a laminate is disclosed that includes (i) a to-be-plated layer containing a polyimide resin having at least a siloxane structure and (ii) a non-thermoplastic polyimide film having a particular structure (for example, see Patent Literature 2).

[Patent Literature 1]

Japanese Patent Application Publication, Tokukaihei, No. 2-180682 A

[Patent Literature 2]

Japanese Patent Application Publication, Tokukai, No. 2006-305966 A

### SUMMARY OF INVENTION

### Technical Problem

However, there is room for improvement of a laminate disclosed in Patent Literature 2, in terms of: its necessity for use of a particular non-thermoplastic polyimide film; and its insufficient soldering heat resistance after moisture absorption. The present invention was made in view of these problems, and an object of the present invention is to provide: a laminate in which properties of a thermoplastic resin, used as a to-be-plated layer, are controlled; a method for subjecting a laminate to a thermal treatment so as to obtain a laminate having (a) high adhesiveness between a resin material and a plating layer and (b) excellent soldering heat resistance after moisture absorption; and a method for manufacturing a flexible printed circuit board obtained with use of the laminate.

### Solution to Problem

As a result of diligent studies in view of the foregoing problems, the inventors of the present invention have reached the following finding: By causing a thermoplastic resin used for a to-be-plated layer to have crystalline properties and performing a thermal treatment at an appropriate timing, it is possible to improve (i) adhesiveness between a resin material and a plating layer and (ii) soldering heat resistance after moisture absorption of a laminate or a flexible printed circuit board obtained with use of the laminate. Thus, the present invention was completed.

That is, the present invention relates to a laminate including at least a polymer film, a to-be-plated layer containing at least a crystalline thermoplastic resin, and a plating layer.

The present invention also relates to a method for producing a laminate including at least a polymer film, a to-be-plated layer containing at least a crystalline thermoplastic resin, and a plating layer, said method including the steps of: A) applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer; and B) heating the laminate. It is preferable that the step A) is performed at least by means of electroless plating; and the step B) is performed just after the electroless plating. Further, it is preferable that this method further includes the step of: C) forming a through-hole through the resin material including at least the polymer film and the to-be-plated layer containing at least the crystalline thermoplastic resin, the step C) being performed before the step A). Furthermore, it is preferable that this method further includes the step of: D) performing a desmear treatment on the resin material including at least the polymer film and the to-be-plated layer containing at least the crystalline thermoplastic resin, the step D) being performed before the step A). Moreover, it is preferable that, in the step B), the laminate is heated at a temperature in a range from a temperature lower by 100° C. than a glass transition temperature of the crystalline thermoplastic resin to a temperature higher by 200° C. than the glass transition temperature. Furthermore, it is preferable that the crystalline thermoplastic resin is crystalline thermoplastic polyimide. Furthermore, it is preferable that a strength ratio Y/X is below 2.0, where X is a peel strength of the plating layer of the laminate obtained by the above method and Y is a peel strength of the plating layer measured after the laminated is heated at a temperature in a range from a temperature lower by 100° C. than the glass transition temperature of the crystalline thermoplastic resin to a temperature higher by 200° C. than the glass transition temperature. The present invention also relates to a method for manufacturing a flexible printed circuit board, including the step of: using a laminate obtained through the above method. The present invention also relates to a flexible printed circuit board manufactured with use of the laminate.

### Advantageous Effects of Invention

A laminate of the present invention, a laminate obtained by a production method of the present invention, and a flexible printed circuit board obtained by using the laminate are excellent in (i) adhesiveness between a resin material and a plating layer and (ii) soldering heat resistance after moisture absorption.

### DESCRIPTION OF EMBODIMENTS

The following will describe an embodiment of the present invention.

(Configuration of Laminate)

A laminate of the present invention is a laminate including at least: a polymer film; a to-be-plated layer containing at least a crystalline thermoplastic resin; and a plating layer. Further, a laminate of the present invention is preferably obtained through a method for producing a laminate including at least a polymer film, a to-be-plated layer containing at least a crystalline thermoplastic resin, and a plating layer, said method including the steps of: applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer; and B) heating the laminate.

A laminate of the present invention only needs to be configured to include at least: a polymer film; a to-be-plated layer containing at least a crystalline thermoplastic resin; and a plating layer. Examples of such the laminate encompass: (i) a laminate including an arrangement of a polymer film/a to-be-plated layer containing at least a crystalline thermoplastic resin/a plating layer; (ii) a laminate including an arrangement of a to-be-plated layer containing at least a crystalline thermoplastic resin/a polymer film/a to-be-plated layer containing at least a crystalline thermoplastic resin/a plating layer; and (iii) a laminate including an arrangement of a plating layer/a to-be-plated layer containing at least a crystalline thermoplastic resin/a polymer film/a to-be-plated layer containing at least a crystalline thermoplastic resin/a plating layer. Further, another layer may be disposed between the polymer film and the to-be-plated layer containing at least the crystalline thermoplastic resin.

Note that the expression “crystalline” herein refers to such a property that exhibits, in the differential scanning calorimetry (DSC), a clear endothermic peak (a temperature at this peak is considered as a melting point) due to transition from the solid phase to the melting phase. On the contrary, “noncrystalline” refers to such a property that does not have a melting point and therefore does not exhibit a clear endothermic peak, but just causes absorption of a small amount of heat around a glass transition temperature. In terms of this, the crystalline property differs from the noncrystalline property.

Note that the expression “thermoplastic resin” herein refers to such a thermoplastic resin film that, when a thermoplastic resin film is produced to have a thickness of 25 μm, the thermoplastic resin film shows, in measurement for a dynamic viscoelastic behavior, a result that a ratio E′1/E′2 is 2.0 or greater, where E′1 is a storage elastic modulus at 30° C. and E′2 is a storage elastic modulus at 350° C. Such the thermoplastic resin film having a thickness of 25 μm is produced by the following method: A thermoplastic resin solution is applied onto a glass substrate so that a thermoplastic resin film will have a final thickness of 25 μm, and the glass substrate having the thermoplastic resin solution applied thereto is dried at 200° C. for 30 minutes in a hot-air oven; consequently, the thermoplastic resin film is formed on the glass substrate. The measurement for the dynamic viscoelastic behavior can be performed in the following manner: The thermoplastic resin film is peeled off, and the thermoplastic resin film is cut into a piece of 9 mm in width and 40 mm in length. Then, the piece is set in an apparatus DMS200 (manufactured by SII NanoTechnology Inc.), and is measured in a tensile mode under the following measurement conditions:

### <Measurement Conditions>

Scanned temperature range: 20° C. to 400° C. (heating rate: 3° C./minute)
Frequency: 5 Hz
Lamp. (target oscillation value): 20 μm
Fbase (minimum value of tension during the measurement): 0 g
F0gain (modulus in a case where tension is changed according to changing in oscillation during the measurement): 3.0.

By performing measurement under the measurement conditions, respective values for a storage elastic modulus E′1 and a storage elastic modulus E′2 in the above scanned temperature range are obtained.

(Polymer Film)

The “polymer film” for used in a laminate of the present invention is preferably a material excellent in low thermal expansion properties, heat resistance, and mechanical properties. Examples of such the material encompass: polyolefins such as polyethylene, polypropylene, and polybutene; polyesters such as an ethylene-vinyl alcohol copolymer, polystyrene, polyethylene terephthalate, polybutylene terephthalate, ethylene-2,6-naphthalate; and films such as the ones made of nylon-6, nylon-11, aromatic polyamide, a polyamide-imide resin, polycarbonate, polyvinyl chloride, polyvinylidene chloride, a polyketone resin, a polysulfone resin, a polyphenylene sulfide resin, a polyetherimide resin, a fluorocarbon resin, a polyallylate resin, a liquid crystal polymer resin, a polyphenylene ether resin, a thermoplastic polyimide resin, or a non-thermoplastic polyimide resin. Of these, the non-thermoplastic polyimide is preferable, since it has low thermal expansion properties, heat resistance, mechanical properties, electrical insulating properties, etc. The non-thermoplastic polyimide is typically produced with use of a polyamic acid as a precursor. The non-thermoplastic polyimide may be fully imidized, or may in part contain a non-imidized precursor, i.e., a polyamic acid. Generally, the non-thermoplastic polyimide refers to such polyimide that does not soften or exhibit adhesiveness even when heated. In the present invention, the non-thermoplastic polyimide refers to such polyimide that maintains its shape without being shrunk or expanded after heated at 450° C. for two minutes in the form of a film, or such polyimide that does not substantially have a glass transition temperature. Note that the glass transition temperature can be calculated based on a value of an inflexion point of a storage elastic modulus measured by a dynamic viscoelasticity measuring apparatus (DMA). Further, what is meant by the expression “does not substantially have a glass transition temperature” is that thermal decomposition starts before it enters into a glass transition state.

A thickness of the polymer film can be optionally determined depending on the use. However, considering a case where the polymer film is used in a generally-used two layer FPC, the thickness is preferably within a range from 1 μm to 100 μm, more preferably within a range from 3 μm to 50 μm, particularly preferably within a range from 7 μm to 18 μm.

A polymer film applicable in a laminate of the present invention is not limited to any particular kind. For example, it is possible to use a commercially-available, known polyimide film. Examples of the commercially-available polyimide film encompass: “Apical” (manufactured by Kaneka Corporation), “Kapton” (manufactured by DuPont, DuPont-Toray Co., Ltd.), and “Upilex” (manufactured by Ube Industries, Ltd.). Alternatively, of course, it is possible to use a heat-resistant polyimide film produced as needed by using a conventionally-known material, manufacturing method, and/or the like. Typical example of this is as follows: Substantially equal molar amounts of aromatic tetracarboxylic acid dianhydride and aromatic diamine are dissolved in an organic solvent, which is then stirred under a controlled temperature condition until polymerization of the aromatic tetracarboxylic dianhydride and the aromatic diamine is completed, so that a varnish of a polyamic acid, which is a precursor, is produced; a heat-resistant polyimide film is obtained by using the vanish of the polyamic acid.

As described previously, polyimide is a material having a higher water absorption rate, compared with other plastics. Therefore, in a case where the polyimide is used as a material of an FPC, it is preferable to use a heat-resistant polyimide film whose water absorption rate is as low as possible, in order to attain further improvement in the soldering heat resistance after moisture absorption. Specifically, it is preferable to use a heat-resistant polyimide film having a water absorption rate of 1.5% or less. The use of a heat resistance polyimide film having a low water absorption rate makes it possible to reduce an absolute amount of water transferring through the material during immersion in a solder bath, thereby leading to improvement in the soldering heat resistance after moisture absorption.

In order to reduce a water absorption rate of a laminate, it is necessary to reduce respective water absorption rates of a polymer film layer and a to-be-plated layer. Examples of specific means therefor encompass: use of a material having a siloxane structure and/or a fluorine functional group; introduction of a polar group such as an ester group into a molecular skeleton so that the polarity of the imide group is reduced; use of a material having a relatively high molecular weight so as to reduce an amount of imide group per unit weight.

(To-Be-Plated Layer)

A to-be-plated layer for use in a laminate of the present invention is made of a thermoplastic resin which is in whole or at least in part crystalline.

Typically, a storage elastic modulus of a noncrystalline thermoplastic resin drastically drops around a glass transition temperature, and then the noncrystalline thermoplastic resin softens. Therefore, in a case where only a noncrystalline thermoplastic resin is used as a thermoplastic resin contained in the to-be-plated layer of the laminate, moisture in the laminate is rapidly released to the outside of the system via the to-be-plated layer thanks to the above phenomenon. This may cause whitening and/or blistering in the laminate and/or the flexible printed circuit board. In order to prevent this, a glass transition temperature of a thermoplastic resin should be increased to around a temperature for a component mounting step that uses soldering. Meanwhile, the inventors of the present inventions have reached the following finding: In order to form a plating film which is strong enough to withstand a solder test after moisture absorption, the use of a noncrystalline thermoplastic resin, a non-thermoplastic resin, or a thermosetting resin each of which simply has a high glass transition temperature does not work adequately, and it is important to use a crystalline thermoplastic resin.

A method for determining whether or not the to-be-plated layer of the present invention contains a crystalline thermoplastic resin may be performed by subjecting the to-be-plated layer to the DSC in order to determine whether or not the to-be-plated layer exhibits a clear endothermic peak (a temperature at this peak is considered as a melting point) due to transition from the solid phase to the melting phase. If the to-be-plated layer exhibits an endothermic peak, this to-be-plated layer is determined to contain at least a crystalline thermoplastic resin. Note that evaluation of whether or not the to-be-plated layer contains a thermoplastic resin may be performed by determining whether or not, in measurement for a dynamic viscoelastic behavior of the to-be-plated layer, a ratio E′1 /E′2 is 2.0 or greater, where E′1 is a storage elastic modulus at 30° C. and E′2 is a storage elastic modulus at 350° C. If a ratio E′1/E′2 is 2.0 or greater, the to-be-plated layer is determined to contain a thermoplastic resin. The measurement for a dynamic viscoelastic behavior may be performed as follows: The to-be-plated layer is cut into a piece of 9 mm in width and 40 mm in length. Then, the piece is set in an apparatus DMS200 (manufactured by SII NanoTechnology Inc.), and is measured in a tensile mode under the following measurement conditions:

### <Measurement Conditions>

Scanned temperature range: 20° C. to 400° C. (heating rate: 3° C./minute)
Frequency: 5 Hz
Lamp. (target oscillation value): 20 μm
Fbase (minimum value of tension during the measurement): 0 g
F0gain (modulus in a case where tension is changed according to changing in oscillation during the measurement): 3.0.

By performing measurement under the measurement conditions, respective values for a storage elastic modulus E′1 and a storage elastic modulus E′2 in the above scanned temperature range are obtained.

As described previously, a crystalline thermoplastic resin contained in a to-be-plated layer of a laminate of the present invention is not limited to any particular kind, examples of which encompass crystalline thermoplastic polyimide, aromatic polyetherketone, polyphenylene sulfide, polyethylene, polypropylene, polybutene, crystalline polybutadiene, polymethylpentene, polyamide, polyester, and polyurethane. Of these, the crystalline thermoplastic polyimide is preferable, in consideration of heat resistance, adhesion with a plating layer, electric properties, etc. The following will describe the crystalline thermoplastic polyimide.

The crystalline thermoplastic polyimide can be obtained by imidization of a polyamic acid, which is a precursor thereof. A method for producing the polyamic acid is not particularly limited, and a conventionally-known method may be employed. Typical examples of this method encompass a method for mixing together a diamine component and an acid dianhydride component in an organic solvent for a polymerization reaction, so that an organic solvent solution of a polyamic acid is obtained. By properly selecting respective structures of the diamine component and the acid dianhydride component used here, it is possible to impart crystalline properties to the thermoplastic polyimide, which is to be obtained by imidization of the polyamic acid produced by the polymerization of the above two components. However, as described above, polyimide is typically obtained by a polymerization reaction of a diamine component and an acid dianhydride component. Therefore, use of either one of a particular diamine component and a particular acid dianhydride component does not always gives a crystalline polyimide. Rather, whether or not crystalline properties are attained largely depends on a particular combination of a diamine component and an acid dianhydride component.

In light of the above viewpoint of the combination, examples of a diamine component and an acid dianhydride component which can be used as materials of crystalline thermoplastic polyimide contained in a to-be-plated layer in the present invention are listed below. Preferable examples of the diamine component encompass: ether diamine such as 1,4-bis(4-aminophenoxy)benzene, 1,3-bis (4-aminophenoxy)benzene, 4,4′-bis(3-aminophenoxy)biphenyl, and 4,4′-bis(4-aminophenoxy)biphenyl; and phenylene diamine such as 1,4-diamino benzene. They are preferable because it is easy to attain crystalline properties with any of them. Preferable examples of the acid dianhydride component encompass pyromellitic acid dianhydride and 3,3′,4,4′-biphenyl tetracarboxylic acid dianhydride. They are preferable because it is easy to attain crystalline properties with any of them. Of course, a diamine component and an acid dianhydride component used as materials of thermoplastic polyimide of the present invention are not limited to the above ones. Alternatively, materials having other structures may be used, as long as thermoplastic polyimide obtained as a result of the particular combination of the diamine component and the acid dianhydride component provides crystalline properties.

In the present invention, examples of a combination of a diamine component and an acid dianhydride component particularly preferable as materials for obtaining crystalline thermoplastic polyimide encompass: a combination of 1,4-bis(4-aminophenoxy)benzene, 1,3-bis(4-aminophenoxy)benzene, and 3,3′,4,4′-biphenyl tetracarboxylic acid dianhydride; and a combination of 1,3-bis (4-aminophenoxy)benzene and 3,3′,4,4′-biphenyl tetracarboxylic acid dianhydride.

In the present invention, there is no particular limitation on conditions for polymerization for obtaining a polyamic acid, which is a precursor of thermoplastic polyimide, the conditions relating to an organic solvent, a polymerization temperature, a polymerization concentration, etc. The polyamic acid may be produced under conventionally-known conditions.

Means for imidizing the polyamic acid thus obtained is also not particularly limited. The means may be a thermal cure method in which imidization is performed with heat only, or a chemical cure method that uses a chemical curing agent such as a chemical dehydrating agent and a catalyst. Alternatively, the thermal cure method and the chemical cure method may be used in combination. Note that this applies not only in producing of thermoplastic polyimide, but also in producing of a non-thermoplastic polyimide film.

The chemical dehydrating agent may be a ring-closing dehydrating agent for a corresponding polyamic acid. Preferable examples of the chemical dehydrating agent encompass aliphatic acid anhydride, aromatic acid anhydride, N,N′-dialkyl carbodiimide, lower aliphatic halide, halogenated lower aliphatic acid anhydride, arylsulfonic acid dihalide, thionyl halide, and a mixture of two or more of these. Particularly, of these, the aliphatic acid anhydride and the aromatic acid anhydride work favorably. The catalyst may be any of a wide variety of components each of which facilitates ring-closing dehydrating effects of the chemical dehydrating agent on a polyamic acid. Examples of the catalyst encompass aliphatic tertiary amine, aromatic tertiary amine, and heterocyclic tertiary amine. Particularly, a nitrogen-containing heterocyclic compound such as imidazole, benzimidazole, isoquinoline, quinoline, or β-picoline is preferable. Further, an organic polar solvent may be optionally introduced into a solution containing the dehydrating agent and the catalyst.

An amount of the chemical dehydrating agent is preferably in a range from 0.5 mol to 5 mole, more preferably in a range from 0.7 mol to 4 mol, with respect to 1 mol of an amic acid unit in a polyamic acid in the solution containing the chemical dehydrating agent and the catalyst. An amount of the catalyst is preferably in a range from 0.05 mol to 3 mol, more preferably in a range from 0.2 mol to 2 mol, with respect to 1 mol of an amic acid unit in a polyamic acid in the solution containing the chemical dehydrating agent and the catalyst. If amounts of the dehydrating agent and the catalyst are less than the respective ranges described above, this may cause insufficient chemical imidization, thereby causing breakage of the film during curing and/or reduction in mechanical strength. By contrast, if these amounts are greater than the above ranges, imidization progresses too rapidly, which may make it difficult to cast the solution in the form of a film.

The foregoing has explained crystalline thermoplastic polyimide of the present invention.

In view of the soldering heat resistance after moisture absorption and the adhesiveness with an electroless plating film, a to-be-plated layer of the present invention preferably contains a crystalline thermoplastic resin in an amount within a range from 50% by weight to 100% by weight, more preferably within a range from 60% by weight to 100% by weight, with respect to 100% by weight of a total weight of the to-be-plated layer of the present invention.

A laminate of the present invention has excellent soldering heat resistance after moisture absorption. Therefore, a crystalline thermoplastic resin contained in a to-be-plated layer preferably has a melting point above a certain level. Specifically, the melting point is preferably within a range from 300° C. to 500° C., more preferably within a range from 320° C. to 480° C. If the melting point is lower than this range, a to-be-plated layer starts softening at a lower temperature, which may result in insufficient improvement in the soldering heat resistance after moisture absorption. By contrast, if the melting point is higher than this range, the adhesiveness with a plating film may be lowered.

In addition to the thermoplastic resin, a to-be-plated layer of a laminate of the present invention may contain organic/inorganic particles such as filler if necessary, in order to control linear expansion coefficient and slipping properties and to improve the adhesiveness and/or the soldering heat resistance, for example. In this case, an amount of the filler to be added may be, e.g., in a range from 0.001% by weight to 50% by weight, with respect to a total weight of the to-be-plated layer.

Further, in order to improve e.g., the adhesiveness and/or the soldering heat resistance, a to-be-plated layer of a laminate of the present invention may contain an additive of any type. The additive may be contained in the to-be-plated layer by addition of the additive to the to-be-plated layer or by application of the additive on a surface of the to-be-plated layer. Specific examples of the additive encompass various kinds of thermosetting resins, thermoplastic resins, and organic thiol compounds. However, the present invention is not limited to these.

Further, a thickness of a to-be-plated layer of a laminate of the present invention is not particularly limited, and can be optionally selected in consideration with a thickness of the laminate as a whole and the adhesiveness with a plating layer, which is to be adhered to the to-be-plated layer. The thickness is preferably within a range from 0.1 μm to 10 μm, more preferably within a range from 0.3 μm to 8 μm. If the to-be-plated layer is formed to be thicker than this range, this may cause a problem that control of a linear expansion coefficient of the laminate is difficult, for example. By contrast, if the to-be-plated layer is formed to be thinner than this range, this may cause insufficient adhesiveness with the plating layer.

(Plating Layer)

A plating layer of the present invention is not limited to any particular type, and may be formed through either one of dry plating and wet plating. Of these, the wet plating is preferable, since the wet plating prevents a pinhole in a plating film and has high productivity.

Examples of the dry plating encompass known methods such as vapor deposition, sputtering, and ion plating. In the case of the dry plating, a desired metal layer may be formed directly, or a desired metal layer may be formed after formation of another film which serves as a base metal.

Examples of the wet plating encompass: direct plating that uses carbon, a palladium catalyst, an organic manganese conductive film, or the like; copper electroless plating; nickel electroless plating; gold electroless plating; silver electroless plating; and tin electroless plating. Any of them is applicable to the present invention.

Of these, in terms of electric properties such as productivity and migration resistance, the electroless plating is preferable. Furthermore, among various kinds of the electroless plating, the copper electroless plating is particularly preferable. The electroless plating may be applied directly. Alternatively, the electroless plating may be applied after pretreatment such as an alkali treatment or a desmear treatment.

The plating layer may be formed by any of the various kinds of plating described above. Alternatively, the plating is performed so as to form a plating layer having a thickness of approximately 1 nm to 5000 nm, electroplating may be performed to adjust the plating to a desired thickness.

The electroplating is not limited to any particular kind, and any kind of electroplating is applicable. However, electroplated copper is preferably applicable, since it has high reliability and fine conductivity. For example, for the electroplated copper, an acidic copper sulfate plating solution or a copper pyrophosphate plating solution may be used. Of these, the use of the acidic copper sulfate plating solution is preferable, since it is easy to keep the acidic copper sulfate plating solution in good condition.

A thickness of the plating layer is not particularly limited. A suitable thickness of the plating layer may be selected depending on the wire width and/or the processing method such as a semi-additive method, a full-additive method, or a subtractive method.

(Method for Producing Laminate)

The present invention is a method for producing a laminate including at least a polymer film, a to-be-plated layer containing at least a crystalline thermoplastic resin, and a plating layer, said method including the steps of: A) applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer: and B) heating the laminate. The following will describe details of a method for producing a laminate of the present invention. However, the present invention is not limited to the description below.

In a method of the present invention for producing a laminate, it is necessary to first produce a resin material including a polymer film and a to-be-plated layer containing at least a crystalline thermosetting resin. As described previously, the polymer film is preferably non-thermoplastic polyimide, and the crystalline thermosetting resin is preferably crystalline thermoplastic polyimide. The following describes an example where the non-thermoplastic polyimide and the crystalline thermoplastic polyimide are used. A method for producing the resin material is not particularly limited, preferable examples of which encompass: (i) a method for forming to-be-plated layer(s) on one of or both of surfaces of a non-thermoplastic polyimide film, which serves as a core; (ii) a method for forming a to-be-plated layer in the form of a sheet, and bonding the to-be-plated layer onto a non-thermoplastic polyimide film, which serves as a core; and (iii) a method for simultaneously forming a non-thermoplastic polyimide layer, which serves as a core, and a to-be-plated layer by means of, e.g., multi-layer extrusion. In a case where the method (i) is employed out of these, if crystalline thermoplastic polyimide does not have solubility, the following procedure is preferable: A solution containing a polyamic acid, which is a precursor of crystalline thermoplastic polyimide, is prepared; subsequently, the solution is applied onto a non-thermoplastic polyimide film, which serves as a core, and the solution is imidized. On the other hand, if the crystalline thermoplastic polyimide has solubility, imidization may be performed in advance. Means for the imidization is not limited to the thermal cure method or the chemical cure method, but may employ a conventionally-known method. Note that polyimide having solubility means, for example, polyimide which is soluble at 25° C. in an amount of 1% by weight or more in 1,3-dioxolan.

(Plating Step A))

Subsequently, by forming a plating layer with use of the resin material, it is possible to obtain a laminate of the present invention.

The plating step A) of the present invention is a step for applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer.

In order to form the plating layer on the resin material, either one of the dry plating and the wet plating may be employed, as described previously. Of these, the wet plating is preferable, in consideration of productivity and its ability to prevent a pinhole. Further, electroless plating is preferable, in consideration of electric properties such as migration resistance. Furthermore, copper electroless plating is particularly preferable. The following will describe a case where the plating layer is formed by means of the copper electroless plating.

(Through-Hole Forming Step C))

The present invention preferably includes, before the plating step A), a through-hole forming step C) for forming a through-hole through the resin material including at least the polymer film and the to-be-plated layer containing at least the crystalline thermoplastic resin. The following will describe the step C).

First, a through-hole is formed through the resin material, as needed. The through-hole can be formed by any known method such as a mechanical drill, laser, or punching.

(Desmear Step D))

The present invention preferably includes, before the plating step A), a desmear step D) for performing a desmear treatment on the resin material including at least the polymer film and the to-be-plated layer containing at least the crystalline thermoplastic resin. This step may be performed after the through-hole forming step C) as described below, or may be performed without performing the through-hole forming step C). The following will describe an embodiment of the step D).

Before the copper electroless plating, pretreatment such as a desmear treatment or an alkali treatment may be performed, for the purpose of removing the resin remaining inside the through-hole and/or improving the adhesiveness with the copper electroless plating on the surface of the resin.

The desmear treatment may be performed by a known method, examples of which encompass: a wet desmear treatment including a swelling step that uses an alkaline aqueous solution or a solution containing an organic solvent, a roughening step that uses an alkaline aqueous solution such as a solution containing sodium permanganate or potassium permanganate, and a neutralization step; and a dry desmear treatment such as the one using plasma. Examples of the alkali treatment encompass the ones using an aqueous sodium hydrate solution or an aqueous potassium hydrate solution.

(Plating Step A))

After the above treatment, palladium is formed. The palladium is used as a nucleus so that the copper electroless plating is deposited on the resin. Thus, a copper electroless plating layer is formed. The plating layer may be formed to have a desired thickness only by the copper electroless plating. Alternatively, after the copper electroless plating layer is deposited to have a thin thickness, copper electroplating may be applied so that the plating layer achieves a desired thickness.

(Heating Step B))

The present invention includes a thermal treatment for heating the laminate after the plating forming step. For the present invention, the inventors of the present invention have found that performing a thermal treatment at an appropriate temperature provides, surprisingly, the following effects: (i) firmer adhesion is obtained between (a) a to-be-plated layer containing at least a crystalline thermoplastic resin and (b) a plating layer formed on the to-be-plated layer; (ii) adhesiveness between the to-be-plated layer and a polymer film is also improved; and, furthermore, (iii) the soldering heat resistance after moisture absorption is improved. Further, the inventors of the present invention have found that: a resin material of the present invention absorbs a large amount of moisture in the process of being immersed in a chemical solution, particularly in a case where a plating layer is formed by means of the wet plating; surprisingly, however, performing a thermal treatment at an appropriate temperature after formation of the plating layer causes the moisture to transmit through the plating layer, which is a metal layer, so that the moisture is removed. This is considered to be part of the reason why the above effects can be obtained. Thus, by performing a thermal treatment at an appropriate temperature on a to-be-plated layer containing a crystalline thermoplastic resin, it is possible to fully bring out the adhesiveness and the soldering heat resistance of the crystalline thermoplastic resin. Here, in order to remove moisture adequately, a thickness of the plating layer just before the thermal treatment is preferably within a range from 1 nm to 5000 nm. If the plating layer is thicker than 5000 nm, moisture is not adequately removed, which may result in failure to attain the effects of improvement in the adhesiveness and in the soldering heat resistance after moisture absorption. By contrast, if the plating layer is thinner than 1 nm, it may be impossible to attain adequate conductivity.

Therefore, in a case where the plating step is performed at least by means of electroless plating, it is preferable to perform the heating step after the electroless plating but before the electroplating, in order to fully bring out the effects.

A surface profile of the plating layer does not significantly change before and after the heating, and maintains a very low surface roughness. This is advantageous for formation of a fine circuit. Further, since the plating layer does not intrude into the inside of an insulating layer, high insulation reliability is maintained. Furthermore, since there is no such a limitation that the thermal treatment should be performed under vacuum or in an inert atmosphere, it is possible to improve the adhesiveness only by a quite simple treatment. Of course, it is possible to perform the thermal treatment under a condition such as under vacuum or in an inert atmosphere, if necessary.

In the present invention, a temperature for the thermal treatment is not particularly limited. However, the temperature is preferably in a range from a temperature lower by 100° C. of a glass transition temperature of the crystalline thermoplastic resin to a temperature higher by 200° C. than the glass transition temperature, more preferably in a range from a temperature lower by 50° C. than the glass transition temperature to a temperature higher by 100° C. than the glass transition temperature. If the temperature for the thermal treatment is below a temperature lower by 100° C. than the glass transition temperature, it may be impossible to improve the adhesiveness and the soldering heat resistance after moisture absorption. By contrast, if the temperature for the thermal treatment is above a temperature higher by 200° C. than the glass transition temperature, the plating layer may be deteriorated, which may impair the adhesiveness. Note that the glass transition temperature of the crystalline thermoplastic resin can be found based on an inflexion point of an endothermic chart observed in a temperature increasing step in the differential scanning calorimetry (DSC).

Time for the thermal treatment is not particularly limited. However, in consideration of productivity and deterioration of the plating layer, the time for the thermal treatment is preferably within a range from 10 seconds to 5 hours, particularly preferably within a range from 60 seconds to 2 hours.

A laminate obtained by a method for producing a laminate including at least a polymer film, a to-be-plated layer containing at least a crystalline thermoplastic resin, and a plating layer, said method including the steps of: A) applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer: and B) heating the laminate can be determined in the following method:

First, for the step A), whether or not a to-be-plated layer of the present invention contains a crystalline thermoplastic resin may be determined, as described previously, by subjecting the to-be-plated layer to the DSC in order to determine whether or not the to-be-plated layer exhibits a clear endothermic peak (a temperature at this peak is considered as a melting point) due to transition from the solid phase to the melting phase. If the to-be-plated layer exhibits an endothermic peak, this to-be-plated layer is determined to contain at least a crystalline thermoplastic resin. Note that evaluation of whether or not the to-be-plated layer contains a thermoplastic resin may be performed by determining whether or not, in measurement for a dynamic viscoelastic behavior of the to-be-plated layer, a ratio E′1/E′2 is 2.0 or greater, where E′1 is a storage elastic modulus at 30° C. and E′2 is a storage elastic modulus at 350° C. If E′1/E′2 is 2.0 or greater, the to-be-plated layer is determined to contain a thermoplastic resin. The measurement for a dynamic viscoelastic behavior may be performed as follows: The to-be-plated layer is cut into a piece of 9 mm in width and 40 mm in length. Then, the piece is set in an apparatus DMS200 (manufactured by SII NanoTechnology Inc.), and is measured in a tensile mode under the following measurement conditions:

### <Measurement Conditions>

Scanned temperature range: 20° C. to 400° C. (heating rate: 3° C./minute)
Frequency: 5 Hz
Lamp. (target oscillation value): 20 μm
Fbase (minimum value of tension during the measurement): 0 g
F0gain (modulus in a case where tension is changed according to changing in oscillation during the measurement): 3.0.

By performing measurement under the measurement conditions, respective values for a storage elastic modulus E′1 and a storage elastic modulus E′2 in the above scanned temperature range are obtained.

Next, for the step B), determination of whether or not a thermal treatment for heating the laminate has been performed may be performed by determining whether or not a strength ratio Y/X is below 2.0, where X is a peel strength of the plating layer of the laminate and Y is a peel strength of the plating layer measured after the laminated is subjected to a thermal treatment at 230° C. for 30 minutes. If the strength ratio Y/X is below 2.0, the thermal treatment for heating the laminate is assumed to have been performed in the step B).

Assumable reasons for this include the following two mechanisms. One of the mechanisms is described below: Before a thermal treatment is performed, a crystalline thermoplastic resin is not crystallized in whole and includes a random part; however, when the crystalline thermoplastic resin is subjected to a thermal treatment and is then cooled, recrystallization occurs, which causes crystal rearrangement. The inventors of the present invention speculate that the to-be-plated layer and the plating layer are firmly adhered to each other at this time. After the thermal treatment is performed once, even if a further thermal treatment is performed, the adhesive strength which has been enhanced once is speculated not to be improved much. This is because that the random part has been already reduced and therefore the effect of the recrystallization is hardly achieved any further. For this reason, it is possible to speculate that a thermal treatment has been already performed by: performing a thermal treatment at 230° C. for 30 minutes on a laminate including at least a polymer film, a to-be-plated layer containing at least a crystalline thermoplastic resin, and a plating layer; and determining whether or not the adhesiveness is improved after the thermal treatment, more specifically, by determining whether or not a strength ratio Y/X is below 2.0, where X is a peel strength of the plating layer of the laminate and Y is a peel strength of the plating layer measured after the laminated is subjected to the thermal treatment at 230° C. for 30 minutes.

The other of the mechanisms is described below. As described previously, it has been found that, in the case where a plating layer is formed by means of the wet plating, a resin material of the present invention absorbs a large amount of moisture in the process of being immersed in a chemical solution; however, performing a thermal treatment at an appropriate temperature after formation of the plating layer causes the moisture to transmit through the plating layer, which is a metal layer, so that the moisture is removed. The inventors of the present invention speculate that: this thermal treatment removes the moisture adequately and consequently prevents plasticization and hydrolysis of the resin, thereby causing the to-be-plated layer and the plating layer to be firmly adhered to each other. After the thermal treatment is performed once, even if a further thermal treatment is performed, the adhesive strength which has been enhanced once is speculated not to be improved much. This is because that the moisture has been adequately removed and therefore the effect of the moisture removal is hardly achieved any further. For this reason, it is possible to speculate that a thermal treatment has been already performed by: performing a thermal treatment at 230° C. for 30 minutes on a laminate including at least a polymer film, a to-be-plated layer containing at least a crystalline thermoplastic resin, and a plating layer; and determining whether or not the adhesiveness is improved after the thermal treatment, more specifically, by determining whether or not a strength ratio Y/X is below 2.0, where X is a peel strength of the plating layer of the laminate and Y is a peel strength of the plating layer measured after the laminated is subjected to a thermal treatment at 230° C. for 30 minutes.

Now, the peel strength of the plating layer can be found as follows: According to JIS C6471 “6.5 peel strength”, a sample is prepared, and a 5-mm width part of the plating layer is peeled off at a peeling angle of 180 degrees at 50 mm/minute; then, a load thereof is measured. In the present invention, the adhesive strength between the to-be-plated layer and the plating layer has been already improved well due to the thermal treatment. Therefore, Y/X is preferably below 2.0, more preferably below 1.5, particularly preferably below 1.3.

The foregoing has explained one example of a method for obtaining a laminate of the present invention.

(Method for Manufacturing Flexible Printed Circuit Board)

The following will describe a flexible printed circuit board that uses a laminate of the present invention. The flexible printed circuit board that uses the laminate of the present invention not only is excellent in the soldering heat resistance after moisture absorption, but also allows fine wires to be formed excellently, since its conductor layer is formed by plating and therefore a thickness of the conductor layer is freely controllable. Therefore, this flexible printed circuit board has an advantage of being suitable for use in electronic information devices.

One example of a method of the present invention for manufacturing a flexible printed circuit board will be described. The wiring can be formed by a subtractive method in which a resist is first formed on a laminate of the present invention, an unnecessary conductor is removed by an etching process, and the resist is removed.

Alternatively, the wiring can be formed by a semi-additive method in which a resist is formed on a laminate of the present invention, pattern electroplating is performed, the resist is removed, and a seed layer is etched.

Subsequently, a solder mask is formed. It is possible to use, as the solder mask, a known material such as a cover lay film, cover lay ink, or a photosensitive cover lay film. Any of them may be selected depending on the use. The solder mask may be formed by a known method.

Afterwards, terminal plating is performed. It is possible to use, for the terminal plating, known plating such as an organic preflux, solder plating, tin plating, or nickel/gold plating. Any of them may be selected depending on the use.

Subsequently, the laminate processed as above is processed into a predetermined shape, and, if necessary, a reinforcement plate is bonded thereto. Through these steps, a flexible printed circuit board is obtained.

The foregoing has explained an example of a printed circuit board that uses a laminate of the present invention, and an example where the printed circuit board is manufactured. However, the present invention is not limited to the above, but may be changed, modified, and/or altered in various ways by a skilled person within the scope of the claims. Of course, the use of the present invention is not limited to the above, but may be available for various uses.

### Examples

The following will describe the present invention in greater details based on Examples and Comparative Examples. However, the present invention is not limited to these. Note that, in each of Examples and Comparative Examples, a melting point (Tm) of a thermoplastic polyimide for use in a to-be-plated layer, a glass transition temperature (Tg) of the thermoplastic polyimide, a peel strength of a plated copper layer of a laminate, and soldering heat resistance after moisture absorption of the laminate were measured or evaluated as described below.

[Melting Point of Thermoplastic Polyimide]

A thermoplastic polyimide precursor solution obtained in each of Synthesization Examples was spread to a shine surface of an 18-μm rolled copper foil (BHY-22B-T; manufactured by Nippon Mining & Metals Co., Ltd.) so that its final thickness would become 20 μm, which was then dried at 130° C. for 3 minutes, at 200° C. for 2 minutes, at 250° C. for 2 minutes, at 300° C. for 2 minutes, and at 350° C. for 1 minute. After the drying, the copper foil was removed by etching, and then drying was performed at 50° C. for 30 minutes. Consequently, a single layer sheet of thermoplastic polyimide was obtained.

The single layer sheet of thermoplastic polyimide thus obtained was subjected to measurement by DSC220 (manufactured by SII NanoTechnology Inc.) using aluminum as a reference. The measurement was performed at temperatures ranging from 0° C. to 450° C., at a heating rate of 10° C./minute and a temperature decrease rate of 40° C./minute. A peak of an endothermic chart observed in a temperature increase step was determined as a melting point.

[Glass Transition Temperature of Thermoplastic Polyimide]

Measurement therefor was performed in the same manner as in the measurement for the melting point. An inflexion point of an endothermic chart observed in a temperature increase step was determined as a glass transition temperature.

[Peel Strength of Plated Copper Layer of Laminate]

According to JIS C6471 “6.5 peel strength”, a sample was prepared, and a 5-mm width part of the plated copper layer was peeled off at a peeling angle of 180 degrees at 50 mm/minute. Then, a load thereof was measured.

[Soldering Heat Resistance after Moisture Absorption of Laminate]

For each of laminates of Examples and Comparative Examples, two samples were prepared. Each sample was subjected to an etching process so that unnecessary portions were removed therefrom and upper and lower plating layers thereof were overlapped in a 1 cm×1.5 cm area. The samples thus obtained were subjected to a moisture absorption treatment in which the samples were left under a humid condition of 40° C. and 90% R.H. for 96 hours. After the moisture absorption treatment, one of the samples was immersed in a solder bath at 260° C. for 10 seconds, and the other of the samples was immersed in a solder bath at 300° C. for 10 seconds. After the immersion in the solder bath, the plating layer on one side of each sample was removed by etching. If no change was found in the appearance of the area where the plating layers had been overlapped, the laminate was determined to be “OK”. If any of whitening, blistering, and exfoliation of the plating layer was found in the appearance of the area where the plating layers had been overlapped, the laminate was determined to be “NG”.

### Synthesization Example 1

### Synthesization of Thermoplastic Polyimide Precursor

To a 2000-ml glass flask, 637.0 g of N,N-dimetylformamide (hereinafter, also referred to as DMF) and 68.2 g of 3,3′,4,4′-biphenyl tetracarboxylic acid dianhydride (hereinafter, also referred to as BPDA) were added. While the resulting mixture was being stirred in a nitrogen atmosphere, 20.3 g of 1,4-bis(4-aminophenoxy)benzene (hereinafter, also referred to as TPE-Q) and 45.4 g of 1,3-bis(4-aminophenoxy)benzene (hereinafter, also referred to as TPE-R) were added to the mixture, which was then stirred at 25° C. for an hour. A solution was separately prepared by dissolving 2.0 g of TPE-R in 27.0 g of DMF and gradually added to the reaction solution while monitoring the viscosity under stirring. The addition and the stirring were ceased when the viscosity reached 1200 poise. Thus, a polyamic acid solution was obtained.

### Synthesization Example 2

### Synthesization of Thermoplastic Polyimide Precursor

To a 2000-ml glass flask, 637.2 g of DMF and 67.8 g of BPDA were added. While the resulting mixture was being stirred in a nitrogen atmosphere, 4.2 g of 4,4′-bis(4-aminophenoxy)biphenyl (hereinafter, also referred to as BAPP) and 62.0 g of TPE-R were added to the mixture, which was then stirred at 25° C. for an hour. A solution was separately prepared by dissolving 2.0 g of TPE-R in 27.0 g of DMF and was gradually added to the reaction solution while monitoring the viscosity under stirring. The addition and the stirring were ceased when the viscosity reached 1200 poise. Thus, a polyamic acid solution was obtained.

### Synthesization Example 3

### Synthesization of Thermoplastic Polyimide Precursor

To a 2000-ml glass flask, 637.0 g of DMF and 68.2 g of BPDA were added. While the resulting mixture was being stirred in a nitrogen atmosphere, 65.8 g of TPE-R was added to the mixture, which was then stirred at 25° C. for an hour. A solution was separately prepared by dissolving 2.0 g of TPE-R in 27.0 g of DMF and gradually added to the reaction solution while monitoring the viscosity under stirring. The addition and the stirring were ceased when the viscosity reached 1200 poise. Thus, a polyamic acid solution was obtained.

### Synthesization Example 4

### Synthesization of Thermoplastic Polyimide Precursor

To a 2000-ml glass flask, 632.4 g of DMF and 56.8 g of BPDA were added. While the resulting mixture was being stirred in a nitrogen atmosphere, 76.8 g of BAPP was added to the mixture, which was then stirred at 25° C. for an hour. A solution was separately prepared by dissolving 2.4 g of BAPP in 31.6 g of DMF and was gradually added to the reaction solution while monitoring the viscosity under stirring. The addition and the stirring were ceased when the viscosity reached 1200 poise. Thus, a polyamic acid solution was obtained.

### Synthesization Example 5

### Synthesization of Thermoplastic Polyimide Precursor

To a 2000-ml glass flask, 645.8 g of DMF, 69.8 g of KF-8010 (siloxane structure-containing diamine) manufactured by Shin-Etsu Chemical Co., Ltd., and 7.2 g of 4,4′-diaminodiphenylether were added. While the resulting mixture was being stirred in a nitrogen atmosphere, 62.5 g of 4,4′-(4,4′-isopropylidenediphenoxy)bis(phthalic anhydride) was added to the mixture, which was then stirred at 25° C. for an hour. Thus, a polyamic acid solution was obtained.

### Example 1

The polyamic acid solution obtained in Synthesization Example 1 was diluted with DMF so as to obtain 8.5% by weight of solid content. The polyamic acid solution was applied to one side of a 17-μm thickness non-thermoplastic polyimide film (Apical 17FP; manufactured by Kaneka Corporation) so that a thermoplastic polyimide layer (which would serve as a to-be-plated layer) would have a final one-side thickness of 4 μm. After that, the non-thermoplastic polyimide film having the polyamic acid solution applied thereto was heated at 140° C. for one minute. Similarly, to the other side of the non-thermoplastic polyimide film, the polyamic acid solution was applied so that a thermoplastic polyimide layer (which would serve as a to-be-plated layer) would have a final one-side thickness of 4 μm. After that, the non-thermoplastic polyimide film having the polyamic acid solution applied thereto was heated at 140° C. for one minute, and subsequently was heated at 390° C. for 20 seconds for imidization. Thus, a resin material including an arrangement of the to-be-plated layer/the non-thermoplastic polyimide film/the to-be-plated layer was obtained.

A through-hole having a diameter of 150 μm was formed through the resin material by a carbonic acid gas laser. Then, the resin material was subjected to desmear and copper electroless plating. Note that the desmear and the copper electroless plating were performed through the steps described in Tables 1 and 2. Subsequently, an electroplated copper layer having a thickness of 18 μm was formed on the electroless plated copper. Thus, a laminate including an arrangement of the plating layer/the to-be-plated layer/the non-thermoplastic polyimide film/the to-be-plated layer/the plating layer was obtained.

TABLE 1
Process for Desmear

| | | Added | Process | Process |
|---|---|---|---|---|
| Step | Composition of solution | amount | temp. | time |
| Swelling | Swelling Dip Securiganth P | 500 ml/l | 60° C. | 5 min. |
| | Sodium hydroxide | 3 g/l | | |
| Washing | | | | |
| with water | | | | |
| Micro | Concentrate compact CP | 550 ml/l | 80° C. | 5 min. |
| etching | Sodium hydroxide | 40 g/l | | |
| Washing | | | | |
| with water | | | | |
| Neutralization | Reduction Solution | 70 ml/l | 40° C. | 5 min. |
| | Securiganth P500 | 50 ml/l | | |
| | Sulfuric acid | | | |
| Washing | | | | |
| with water | | | | |

TABLE 2
Process for Copper Electroless Plating

| | | Added | | Process | Process |
|---|---|---|---|---|---|
| Step | Composition of solution | amount | | temp. | time |
| Cleaner | Cleaner Securiganth 902 | 40 | ml/l | 60° C. | 5 min. |
| con- | | | | | |
| ditioner | | | | | |
| Washing | | | | | |
| with water | | | | | |
| Predipping | Predip Neoganth-B | 20 | ml/l | Room | 1 min. |
| | Sulfuric acid | 1 | ml/l | temp. | |
| Providing | Activator Neoganth 834 | 40 | ml/l | 35° C. | 5 min. |
| catalyst | conc | | | | |
| | Sodium hydroxide | 4 | g/l | | |
| | Boric acid | 5 | g/l | | |
| Washing | | | | | |
| with water | | | | | |
| Activation | Reducer Neoganth WA | 5 | ml/l | Room | 2 min. |
| | Sodium hydroxide | 25 | g/l | temp. | |
| Washing | | | | | |
| with water | | | | | |
| Copper | Printoganth MV Basic | 85 | ml/l | 32° C. | 15 min. |
| electroless | Printoganth MV Copper | 45 | ml/l | | |
| plating | Reducer Cu | 16 | ml/l | | |
| | Printoganth MV Starter | 8 | ml/l | | |
| | Printoganth MV Stabilizer | 1.5 | ml/l | | |
| | Plus | | | | |

Table 3 shows a melting point (Tm) and a glass transition temperature (Tg) of the thermoplastic polyimide used for the to-be-plated layer of the laminate, and the result of evaluation of characteristics of the laminate.

TABLE 3

| | | | | | | Soldering heat | | | | | |
|---|---|---|---|---|---|---|---|---|---|---|---|
| | | | | Conditions | | resistance after | | | Conditions | | |
| | | | | for | | moisture | | Blistering | for thermal | | |
| | | | Polymer | thermal | Peel | absorption | | after | treatment for | Peel | |
| | Tg (° C.) | Tm (° C.) | film | treatment | strength X | 260° C. | 300° C. | reflow | determination | strength Y | Y/X |
| Ex. 1 | 230 | 400 | 17FP | Not | 3 N/cm | OK | OK | — | 230° C./ | 6 N/cm | 2.0 |
| | | | | performed | | | | | 30 min. | | |
| Ex. 2 | 211 | 392 | 17FP | Not | 3 N/cm | OK | OK | — | 230° C./ | 6 N/cm | 2.0 |
| | | | | performed | | | | | 30 min. | | |
| Ex. 3 | 210 | 395 | 17FP | Not | 3 N/cm | OK | OK | — | 230° C./ | 7 N/cm | 2.3 |
| | | | | performed | | | | | 30 min. | | |
| Ex. 4 | 210 | 395 | 25NP1 | Not | 3 N/cm | OK | OK | — | 230° C./ | 7 N/cm | 2.3 |
| | | | | performed | | | | | 30 min. | | |
| Ex. 5 | 210 | 395 | 17FP | Not | — | — | — | No | — | — | — |
| | | | | performed | | | | blistering | | | |
| Ex. 6 | 230 | 400 | 17FP | 230° C./ | 7 N/cm | OK | OK | — | 230° C./ | 7 N/cm | 1.0 |
| | | | | 30 min. | | | | | 30 min. | | |
| Ex. 7 | 211 | 392 | 17FP | 230° C./ | 7 N/cm | OK | OK | — | 230° C./ | 7 N/cm | 1.0 |
| | | | | 30 min. | | | | | 30 min. | | |
| Ex. 8 | 210 | 395 | 17FP | 230° C./ | 8 N/cm | OK | OK | — | 230° C./ | 8 N/cm | 1.0 |
| | | | | 30 min. | | | | | 30 min. | | |
| Ex. 9 | 210 | 395 | 25NP1 | 230° C./ | 8 N/cm | OK | OK | — | 230° C./ | 8 N/cm | 1.0 |
| | | | | 30 min. | | | | | 30 min. | | |
| Ex. 10 | 210 | 395 | 17FP | 230° C./ | 4 N/cm | OK | NG | — | 230° C./ | 6 N/cm | 1.5 |
| | | | | 30 min. | | | | | 30 min. | | |
| Ex. 11 | 210 | 395 | 17FP | 230° C./ | — | — | — | No | — | — | — |
| | | | | 30 min. | | | | blistering | | | |

Abbreviation:
“Ex.” stands for “Example”.

### Example 2

A laminate was obtained by performing the same operation as in Example 1, except that the polyamic acid solution obtained in Synthesization Example 2 was used instead of the polyamic acid solution obtained in Synthesization Example 1. Table 3 shows a melting point (Tm) and a glass transition temperature (Tg) of the thermoplastic polyimide used for the to-be-plated layer of the laminate, and the result of evaluation of characteristics of the laminate.

### Example 3

A laminate was obtained by performing the same operation as in Example 1, except that the polyamic acid solution obtained in Synthesization Example 3 was used instead of the polyamic acid solution obtained in Synthesization Example 1. Table 3 shows a melting point (Tm) and a glass transition temperature (Tg) of the thermoplastic polyimide used for the to-be-plated layer of the laminate, and the result of evaluation of characteristics of the laminate.

### Example 4

A laminate was obtained by performing the same operation as in Example 3, except that a 25-μm thickness non-thermoplastic polyimide film (Apical 25NPI; manufactured by Kaneka Corporation) was used instead of the 17-μm thickness non-thermoplastic polyimide film (Apical 17FP; manufactured by Kaneka Corporation). Table 3 shows a melting point (Tm) and a glass transition temperature (Tg) of the thermoplastic polyimide used for the to-be-plated layer of the laminate, and the result of evaluation of characteristics of the laminate.

### Example 5

In the same manner as in Example 3, a resin material having an arrangement of a to-be-plated layer/a non-thermoplastic polyimide film/a to-be-plated layer was obtained. Then, in the same manner as in Example 3, a through-hole having a diameter of 150 μm was formed through the resin material by a carbonic acid gas laser. After that, the resin material was subjected to desmear and copper electroless plating. After the copper electroless plating, the resin material was subjected to a thermal treatment in a hot-air oven at 230° C. for 30 minutes. A plating resist was formed on a laminate thus obtained, and then the laminate was subjected to copper pattern electroplating. Subsequently, the plating resist was removed, and flash etching was performed. Consequently, wirings each having a wire width of 10 μm and a wire-to-wire space of 10 μm were formed on both sides of the laminate. Furthermore, a commercially-available cover lay film was laminated thereon, so that a solder mask was formed. Subsequently, the laminate was subjected to solder plating, and was put into a reflow furnace at 260° C. so that a lead component was mounted thereon. A flexible printed circuit board with the lead component, obtained in this manner, did not have any blistering even after the reflow.

### Example 6

A laminate was obtained by performing the same operation as in Example 1, except that a thermal treatment in a hot-air oven at 230° C. for 30 minutes was performed after the copper electroless plating. Table 3 shows a melting point (Tm) and a glass transition temperature (Tg) of the thermoplastic polyimide used for the to-be-plated layer of the laminate, and the result of evaluation of characteristics of the laminate.

### Example 7

A laminate was obtained by performing the same operation as in Example 2, except that a thermal treatment in a hot-air oven at 230° C. for 30 minutes was performed after the copper electroless plating. Table 3 shows a melting point (Tm) and a glass transition temperature (Tg) of the thermoplastic polyimide used for the to-be-plated layer of the laminate, and the result of evaluation of characteristics of the laminate.

### Example 8

A laminate was obtained by performing the same operation as in Example 3, except that a thermal treatment in a hot-air oven at 230° C. for 30 minutes was performed after the copper electroless plating. Table 3 shows a melting point (Tm) and a glass transition temperature (Tg) of the thermoplastic polyimide used for the to-be-plated layer of the laminate, and the result of evaluation of characteristics of the laminate.

### Example 9

A laminate was obtained by performing the same operation as in Example 4, except that a thermal treatment in a hot-air oven at 230° C. for 30 minutes was performed after the copper electroless plating. Table 3 shows a melting point (Tm) and a glass transition temperature (Tg) of the thermoplastic polyimide used for the to-be-plated layer of the laminate, and the result of evaluation of characteristics of the laminate.

### Example 10

A laminate was obtained by the same operation as in Example 8, except that a thermal treatment in a hot-air oven at 230° C. for 30 minutes was performed after the copper electroplating, not after the copper electroless plating. Table 3 shows a melting point (Tm) and a glass transition temperature (Tg) of the thermoplastic polyimide used for the to-be-plated layer of the laminate, and the result of evaluation of characteristics of the laminate.

### Example 11

A flexible printed circuit board with a lead component was obtained by the same operation as in Example 5, except that a thermal treatment in a hot-air oven at 230° C. for 30 minutes was performed after the copper electroless plating. This flexible printed circuit board with the lead component did not have any blistering even after the reflow at 260° C.

### Comparative Example 1

A laminate was obtained by the same operation as in Example 1, except that the polyamic acid solution obtained in Synthesization Example 4 was used instead of the polyamic acid solution obtained in Synthesization Example 1. Table 4 shows a melting point (Tm) and a glass transition temperature (Tg) of the thermoplastic polyimide used for the to-be-plated layer of the laminate, and the result of evaluation of characteristics of the laminate.

TABLE 4

| | | | | | | Soldering heat | | | | | |
|---|---|---|---|---|---|---|---|---|---|---|---|
| | | | | Conditions | | resistance after | | | Conditions | | |
| | | | | for | Peel | moisture | | Blistering | for thermal | Peel | |
| | | | Polymer | thermal | strength X | absorption | | after | treatment for | strength Y | |
| | Tg (° C.) | Tm (° C.) | film | treatment | (N/cm) | 260° C. | 300° C. | reflow | determination | (N/cm) | Y/X |
| C. Ex. 1 | 240 | — | 17FP | Not | 2 | NG | NG | — | 230° C./ | 3 | 1.5 |
| | | | | performed | | | | | 30 min. | | |
| C. Ex. 2 | 240 | — | 17FP | 230° C./ | 4 | NG | NG | — | 230° C./ | 4 | 1.0 |
| | | | | 30 min. | | | | | 30 min. | | |
| C. Ex. 3 | 60 | — | 17FP | 150° C./ | 8 | NG | NG | — | 150° C./ | 8 | 1.0 |
| | | | | 30 min. | | | | | 30 min. | | |

Abbreviation:
“C. Ex.” stands for “Comparative Example”.

### Comparative Example 2

A laminate was obtained by the same operation as in Comparative Example 1, except that a thermal treatment in a hot-air oven at 230° C. for 30 minutes was performed after the copper electroless plating. Table 4 shows a melting point (Tm) and a glass transition temperature (Tg) of the thermoplastic polyimide used for the to-be-plated layer of the laminate, and the result of evaluation of characteristics of the laminate.

### Comparative Example 3

A laminate was obtained by the same operation as in

Comparative Example 1, except that (i) the polyamic acid solution obtained in Synthesization Example 5 was used instead of the polyamic acid solution obtained in Synthesization Example 4 and (ii) a thermal treatment in a hot-air oven at 150° C. for 30 minutes was performed after the copper electroless plating. Table 4 shows a melting point (Tm) and a glass transition temperature (Tg) of the thermoplastic polyimide used for the to-be-plated layer of the laminate, and the result of evaluation of characteristics of the laminate.

1. A laminate comprising at least:
a polymer film;
a to-be-plated layer containing at least a crystalline thermoplastic resin; and
a plating layer.

2. A method for producing a laminate including at least a polymer film, a to-be-plated layer containing at least a crystalline thermoplastic resin, and a plating layer,
said method comprising the steps of:
A) applying plating to a resin material including at least a polymer film and a to-be-plated layer containing at least a crystalline thermoplastic resin, in order to produce a laminate including at least the polymer film, the to-be-plated layer containing at least the crystalline thermoplastic resin, and a plating layer; and
B) heating the laminate.

3. The method as set forth in claim 2, wherein:
the step A) is performed at least by means of electroless plating; and
the step B) is performed just after the electroless plating.

4. The method as set forth in claim 2, further comprising the step of:
C) forming a through-hole through the resin material including at least the polymer film and the to-be-plated layer containing at least the crystalline thermoplastic resin,
the step C) being performed before the step A).

5. The method as set forth in claim 2, further comprising the step of:
D) performing a desmear treatment on the resin material including at least the polymer film and the to-be-plated layer containing at least the crystalline thermoplastic resin,
the step D) being performed before the step A).

6. The method as set forth in claim 2, wherein:
in the step B), the laminate is heated at a temperature in a range from a temperature lower by 100° C. than a glass transition temperature of the crystalline thermoplastic resin to a temperature higher by 200° C. than the glass transition temperature.

7. The method as set forth in claim 2, wherein:
the crystalline thermoplastic resin is crystalline thermoplastic polyimide.

8. A laminate comprising at least:
a polymer film;
a to-be-plated layer containing at least a crystalline thermoplastic resin; and
a plating layer,
a strength ratio Y/X being below 2.0, where X is a peel strength of the plating layer of the laminate and Y is a peel strength of the plating layer measured after the laminated is heated at 230° C. for 30 minutes.

9. A method for manufacturing a flexible printed circuit board, comprising the step of:
using a laminate obtained through a method as set forth in claim 2.

10. A flexible printed circuit board manufactured with use of a laminate as set forth in claim 1.

11. A flexible printed circuit board manufactured with use of a laminate as set forth in claim 8.
